(19) United States
(12) Patent Application Publication
(10) Pub. No.: US 2009/0021848 A1
(43) Pub. Date: Jan. 22, 2009

(54) APPARATUS AND METHOD OF DRIVING PIEZOELECTRIC ACTUATOR FOR AUTO-FOCUS

(75) Inventor: Youn Joong Lee, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/176,082

(22) Filed: Jul. 18, 2008

(30) Foreign Application Priority Data
Jul. 19, 2007 (KR) 10-2007-0072247

(51) Int. Cl. G02B 7/02

(52) U.S. Cl. 359/824

(57) ABSTRACT

There is provided an apparatus for driving a piezoelectric actuator moving a lens for auto-focus, the apparatus including: a lens position sensing unit sensing a position of the lens and generating a sensed lens position value; a lens control unit comparing the sensed lens position value with a target lens position value for auto-focus to determine a moving direction of the lens; and an actuator driving unit generating an actuator driving signal for driving the piezoelectric actuator to move the lens in the moving direction determined by the lens control unit, wherein the lens control unit temporarily stops the operation of the actuator driving unit, and receives the sensed lens position value corresponding to the lens position sensed by the lens position sensing unit and compares the sensed lens position value with the target lens position value while the operation of the actuator driving unit is temporarily stopped.

### CROSS-REFERENCE TO RELATED APPLICATIONS

This application claims the priority of Korean Patent Application No. 2007-72247 filed on Jul. 19, 2007, in the Korean Intellectual Property Office, the disclosure of which is incorporated herein by reference.

### BACKGROUND OF THE INVENTION

1. Field of the Invention

The present invention relates to an apparatus and method of driving a piezoelectric actuator, and more particularly, to an apparatus and method of driving a piezoelectric actuator that can improve auto-focus performance of a camera module by removing switching noise caused by a driving pulse.

2. Description of the Related Art

With the improvement in performance of mobile communication terminals and the trend of digital convergence, camera modules for terminals have become components necessary for the terminals. Further, as there has been an increasing need for additional functions and improvement in performance of a camera included in the mobile communication terminal, a zoom function, an auto-focus function, and the like are built into the camera module of the mobile communication terminal.

In particular, in order to implement the auto-focus function, a unit that moves a lens to a desired position is required. An actuator is generally used to move the lens. Examples of the actuator may include a voice coil actuator (VCA) and a piezoelectric actuator. In order for the actuator to be applied to the mobile communication terminal, a reduction in size and low power consumption are required. In general, the piezoelectric actuator is used because it has a smaller size and lower power consumption than the VCA.

Further, in order to implement the auto-focus function, a unit that senses the current position of the lens is inevitably used to move the lens to the desired position. As the unit that senses the lens position, a photo interrupter (PI) or a hall sensor is used.

In the related art, a process of sensing the lens position and a process of moving the lens are performed at the same. That is, as shown in FIG. 1, a process of generating a sensing signal (lens position sensing voltage) when the PI or the hall sensor senses a lens position and a process of generating an actuator driving signal for driving the piezoelectric actuator so as to move the lens are performed at the same time. As shown in FIG. 1, since pulsed current having a large peak value is used to generate the driving signal for driving the piezoelectric actuator, switching noise indicated by ‘N’ occurs in the sensing signal (lens position sensing voltage) obtained by sensing the lens position.

Therefore, when the method of driving the piezoelectric actuator according to the related art is used, the position may not be accurately sensed due to the switching noise that occurs in the sensing signal obtained by sensing the lens position. This may cause deterioration in auto-focus performance.

### SUMMARY OF THE INVENTION

An aspect of the present invention provides an apparatus for driving a piezoelectric actuator that detects a position of a lens while influences of switching noise caused by a driving signal used to drive the piezoelectric actuator are removed, thereby accurately detecting the position of the lens and thus improving the auto-focus performance.

According to an aspect of the present invention, there is provided an apparatus for driving a piezoelectric actuator moving a lens for auto-focus, the apparatus including: a lens position sensing unit sensing a position of the lens and generating a sensed lens position value; a lens control unit comparing the sensed lens position value with a target lens position value for auto-focus to determine a moving direction of the lens; and an actuator driving unit generating an actuator driving signal for driving the piezoelectric actuator to move the lens in the moving direction determined by the lens control unit, wherein the lens control unit temporarily stops the operation of the actuator driving unit, and receives the sensed lens position value corresponding to the lens position sensed by the lens position sensing unit and compares the sensed lens position value with the target lens position value while the operation of the actuator driving unit is temporarily stopped.

The lens position sensing unit may includes: a position sensor sensing the position of the lens and outputting an analog signal corresponding to the sensed position of the lens; and an analog-to-digital converter converting the analog signal into a digital format and generating the sensed lens position value.

The lens control unit may control the analog-to-digital converter so that the analog-to-digital converter generates a new sensed lens position value by using an analog signal input from the position sensor while the operation of the actuator driving unit is temporarily stopped, and maintains the previous sensed lens position value while the actuator driving unit operates.

According to another aspect of the present invention, there is provided a method of driving a piezoelectric actuator comparing a target lens position value determined for auto-focus with a sensed lens position value obtained by sensing the actual position of a lens and moving the lens to make the target lens position value and the sensed lens position value equal to each other, the method including: determining the target lens position value; determining whether or not to generate a new sensed lens position value; stopping generation of a driving signal for driving the piezoelectric actuator when it is determined to generate a new sensed lens position; and comparing the sensed lens position value, generated while the generation of the driving signal is stopped, with the target lens position value and generating a driving signal for driving the piezoelectric actuator according to a result of the comparison.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the relationship between a lens position sensing voltage and an actuator driving signal to illustrate a method of driving a piezoelectric actuator according to an exemplary embodiment of the present invention;

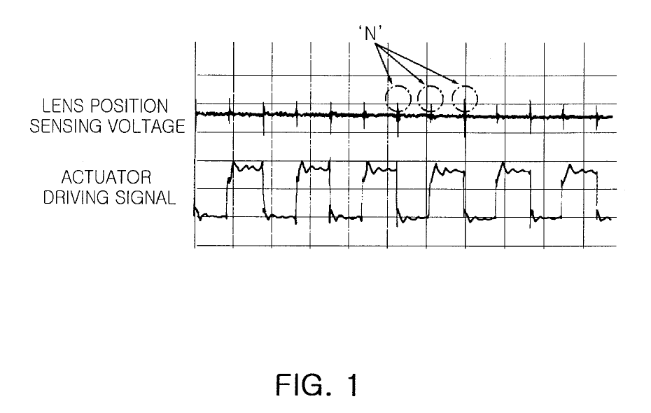

FIG. 2 is a block diagram illustrating a configuration of a piezoelectric actuator according to an exemplary embodiment of the present invention;

FIG. 3 is a flowchart illustrating a method of driving a piezoelectric actuator according to an exemplary embodiment of the present invention;

FIG. 4 is a flowchart illustrating a process of driving a piezoelectric actuator for auto-focus in the method of driving a piezoelectric actuator according to the exemplary embodiment of the present invention; and

FIG. 5 is a view illustrating the relationship between a lens position sensing voltage and an actuator driving signal to illustrating the method of illustrate a piezoelectric actuator according to the exemplary embodiment of the present invention.

### DETAILED DESCRIPTION OF THE PREFERRED EMBODIMENT

The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

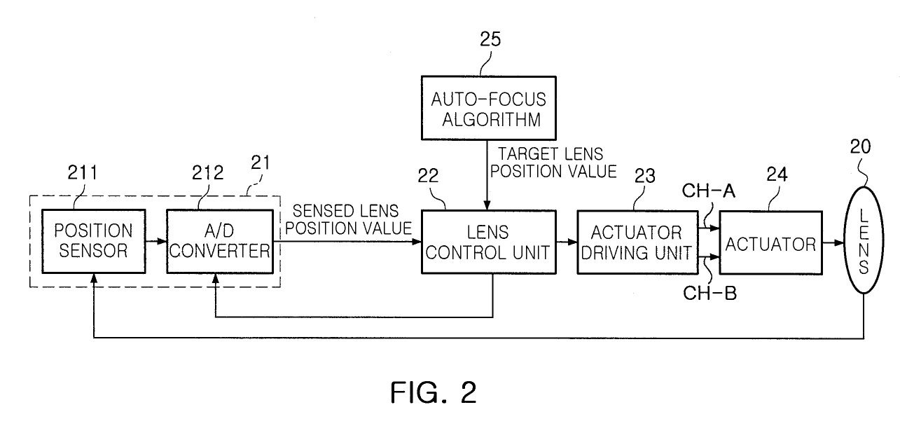

FIG. 2 is a block diagram illustrating an apparatus for driving a piezoelectric actuator according to an exemplary embodiment of the present invention.

Referring to FIG. 2, an apparatus for driving a piezoelectric actuator according to an exemplary embodiment of the invention may include a lens position sensing unit 21, a lens control unit 22, and an actuator driving unit 23. The embodiment of the invention can be applied to a camera module that includes a lens 20 that varies in position to achieve auto focus and a piezoelectric actuator 24 that is provided as a unit that moves the lens 20.

The lens position sensing unit 21 senses the current position of the lens 20 that is moving, generates a sensed lens position value corresponding to the sensed current position, and outputs the sensed lens position value. The lens position sensing unit 21 may include a position sensor 211 and an analog-to-digital (A/D) converter 212. The position sensor 211 senses a position of the lens 20 and outputs an analog signal corresponding to the sensed position. The A/D converter 212 converts the analog signal of the position sensor 211 into a digital format to generate the sensed lens position value.

As the position sensor 211, various types of sensors known in the field can be selectively used. In particular, the position sensor 211 may be formed of a photo interrupter (PI) and a hall sensor.

The A/D converter 212 converts the analog signal (voltage value) corresponding to the lens position sensed by the position sensor 211 into the digital format and generates the sensed lens position value in the digital format to be input to the lens control unit 22.

The lens control unit 22 compares the sensed lens position value generated by the lens position sensing unit 21 with a target lens position value for auto focus and determines a moving direction of the lens 10. Further, the actuator driving unit 23 generates an actuator driving signal for driving the piezoelectric actuator 24 so as to move the lens 20 in the moving direction determined by the lens control unit 22.

The sensed lens position value contains information about the current lens position sensed by the lens position sensing unit 21. The target lens position value is determined by an auto-focus algorithm 25 that is included in an image signal processor (ISP) in the camera module. The auto-focus algorithm 25 automatically calculates the lens position by which focus on a subject can be obtained, and generates the target lens position value that is a signal containing information corresponding to the lens position.

The lens control unit 22 compares the sensed lens position value with the target lens position value to determine the moving direction of the lens 20, such that the actuator driving unit 23 can appropriately move the lens in the moving direction. For example, when the sensed lens position value is smaller than the target lens position value, the lens control unit 22 controls so that the actuator driving unit 23 outputs a piezoelectric actuator driving signal (driving pulse) through a channel-B CH-B and maintains a channel-A CH-A at a high level. In this way, the piezoelectric actuator 24 moves the lens 20 forward. Further, the lens control unit 22 causes the position sensor 211 to continuously sense a new position of the lens 20 and drives the piezoelectric actuator 24 until the sensed lens position value is substantially the same as the target lens position value. In the same manner, when the sensed lens position value is larger than the target lens position value, the lens control unit 22 causes the actuator driving unit 23 to output a piezoelectric actuator driving signal (driving pulse) through the channel-A CH-A and maintains the channel-B CH-B at a high level. In this way, the piezoelectric actuator 24 moves the lens 20 backward. Further, the lens control unit 22 causes the position sensor 211 to newly sense the position of the lens 20 and drives the piezoelectric actuator 24 until the sensed lens position value is substantially the same as the target lens position value. In the above-described example, the relationship between the driving signal for driving the piezoelectric actuator and the moving direction of the lens can be changed according to the design. However, the present invention is not limited thereto.

In the embodiment of the invention, the lens control unit 22 temporarily stops the operation of the actuator driving unit 23 while the lens position sensing unit 21 senses the current lens position. That is, while the operation of the actuator driving unit 23 is temporarily stopped, the lens control unit 22 receives the sensed lens position value corresponding to the lens position sensed by the lens position sensing unit 21 and compares the sensed lens position value with the target lens position value. In the embodiment of the invention, while the lens position sensing unit 21 senses the position of the lens and generates the sensing value with respect to the sensed lens position, the control unit 22 stops the operation of the actuator driving unit 23 to stop the generation of the driving signal for driving the piezoelectric actuator. In this way, switching noise occurring when sensing the lens position by using the driving signal for driving the piezoelectric actuator is removed to thereby accurately sense the lens position and further increase autofocus accuracy.

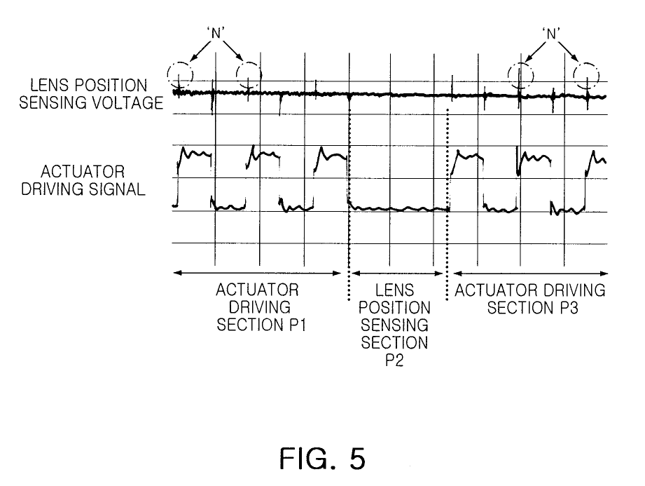

FIG. 5 is a view illustrating the relationship between a driving signal of a piezoelectric actuator and a lens position sensing voltage. Referring to FIG. 5, in piezoelectric actuator driving sections P1 and P3, switching noise N occurs in the lens position sensing voltage due to the piezoelectric actuator driving signal. However, in a section P2 where the piezoelectric actuator driving signal is not generated, there is no switching noise in the lens position sensing voltage. Therefore, the section where the piezoelectric actuator driving signal is not generated is used as the section P2 where the lens position is sensed, the switching noise in the lens position sensing voltage is removed to thereby accurately sense the lens position.

Preferably, when the operation of the actuator driving unit 23 is temporarily stopped, the lens control unit 22 controls so that the A/D converter 212 newly generates a sensed lens position value by using the analog signal that is input from the position sensor 211, and when the actuator driving unit 23 performs its operation, the lens control unit 22 controls the A/D converter 212 to maintain the previous sensed lens position value. In the embodiment of the invention, the position sensor 211 continuously senses the position of the lens and outputs the sensed position, and the lens control unit 22 stops the operation of the actuator driving unit 23 when it needs to receive the sensed lens position value. Then, while the operation of the actuator driving unit 23 is temporarily stopped, the lens control unit 22 causes the A/D converter 212 to convert the analog signal input from the position sensor 211 into the digital format and generate the sensed lens position value. On the other hand, while the actuator driving unit 23 performs its operation, the lens control unit 22 causes the A/D converter 212 not to convert the analog signal input from the position sensor 211 but maintain the previously converted digital signal. The operation of controlling the A/D converter 212 is more efficient than the operation of turning on and off the position sensor 211 according to the operation of the actuator driving unit 23.

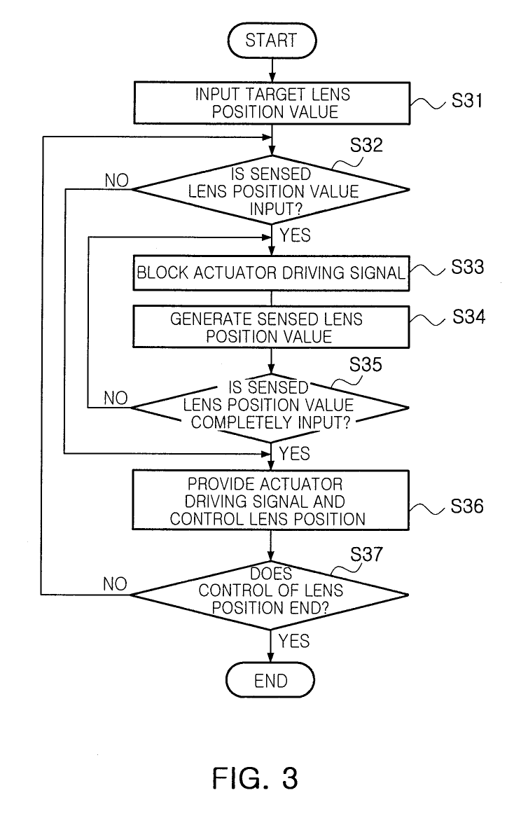

According to the embodiment of the invention, there is provided a method of driving a piezoelectric actuator by using the above-described apparatus for driving a piezoelectric actuator. FIG. 3 is a flowchart illustrating a method of driving a piezoelectric actuator according to another exemplary embodiment of the invention.

Referring to FIGS. 2 and 3, the method of driving a piezoelectric actuator according to another exemplary embodiment of the invention begins with an operation of determining a target lens position value (S31). The target lens position value is determined by the auto-focus algorithm 25 of the camera module. The target lens position value is input to the lens control unit 22.

Then, it is determined whether or not to generate a new sensed lens position value (S32). At operation S32, the lens control unit 22 causes the lens position sensing unit 21 to generate a new sensed lens position value to be compared with the target lens position value that is input to move the lens for auto-focus and determines whether or not to receive the sensed lens position value.

Then, when it is determined that a new sensed lens position value needs to be generated, the lens control unit 22 stops the generation of a driving signal for driving the piezoelectric actuator 24 (S33). That is, in order to prevent switching noise from occurring due to the driving signal for driving the piezoelectric actuator 24, the lens control unit 22 stops the operation of the actuator driving unit 23 to block the piezoelectric actuator driving signal.

Then, while the generation of the driving signal is stopped, the sensed lens position value is generated (S34). When the generated sensed lens position value is completely input to the lens control unit 22 (S35), the lens control unit 22 compares the sensed lens position value with the target lens position value, generates a driving signal for driving the piezoelectric actuator according to a result of the comparison, and controls the lens position (S36).

The above-described processes may be repeated until the control of the lens position ends (S37), that is, until auto-focus is completed.

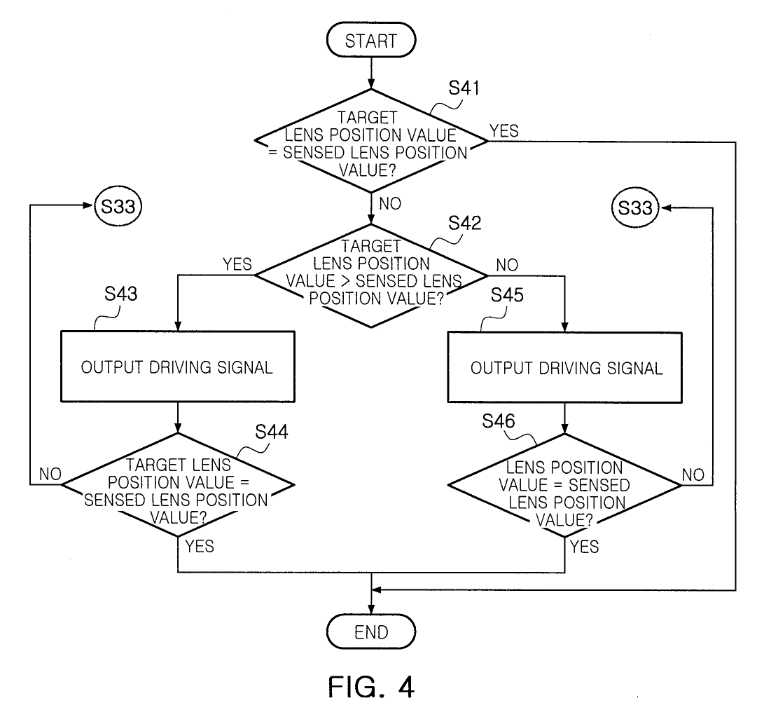

FIG. 4 is a detailed flowchart illustrating a method of driving a piezoelectric actuator for auto-focus according to an embodiment of the present invention. It can be understood that FIG. 4 illustrates operations S36 and S37 in more detail.

Referring to FIG. 4, after the sensed lens position value is input, the lens control unit 22 compares the target lens position value with the sensed lens position value, and if the target lens position value is equal to the sensed lens position value (S41), the lens control unit 22 determines that auto-focus is completed and does not move the lens.

When the target lens position value is not equal to the sensed lens position value, the lens control unit 22 compares the target lens position value with the sensed lens position value (S42). For example, when the target lens position value is larger than the sensed lens position value, the lens control unit 22 controls so that the actuator driving unit 23 transmits the driving signal (driving pulse) to the piezoelectric actuator 24 through the channel B CH-B and maintains the channel A CH-A at a high level (S43). In this way, the lens control unit 22 can move the lens forward. Further, when the target lens position value is smaller than the sensed lens position value, the lens control unit 22 controls so that the actuator driving unit 23 transmits the driving signal (driving pulse) to the piezoelectric actuator 24 through the channel A CH-A and maintains the channel B CH-B at a high level (S45). In this way, the lens control unit 22 can move the lens backward.

Then, after the lens is moved, it is determined whether the target lens position value and the sensed lens position value are equal to each other or not (S44 and S45). If the values are not the same as each other, the process flow returns to operation S33 in FIG. 3, and a new sensed lens position value is input and the above-described process of moving the lens may be repeated. The operations S44 and S45 can be considered substantially identical to the operation S37.

As described above, in the embodiment of the invention, when the lens position sensing unit that senses a lens position senses the lens position and generates a sensed lens position value to be compared with a target lens position value, the operation of the actuator driving unit that applies a driving signal to the piezoelectric actuator is stopped to thereby prevent generation of switching noise caused by the piezoelectric actuator driving signal. The movement of the lens is controlled by using a lens sensing signal (lens sensing voltage) that has no switching noise component to thereby perform accurate auto-focus.

As set forth above, according to the exemplary embodiments of the invention, it is possible to accurately sense the lens position by preventing switching noise caused by a driving signal used to drive the piezoelectric actuator from occurring in a sensed lens position signal. Therefore, the auto-focus performance of the camera module can be improved.

While the present inventions been shown and described in connection with the exemplary embodiments, it will be apparent to those skilled in the art that modifications and variations can be made without departing from the spirit and scope of the invention as defined by the appended claims.

What is claimed is:

1. An apparatus for driving a piezoelectric actuator moving a lens for auto-focus, the apparatus comprising:
a lens position sensing unit sensing a position of the lens and generating a sensed lens position value;
a lens control unit comparing the sensed lens position value with a target lens position value for auto-focus to determine a moving direction of the lens; and
an actuator driving unit generating an actuator driving signal for driving the piezoelectric actuator to move the lens in the moving direction determined by the lens control unit,
wherein the lens control unit temporarily stops the operation of the actuator driving unit, and receives the sensed lens position value corresponding to the lens position sensed by the lens position sensing unit and compares the sensed lens position value with the target lens position value while the operation of the actuator driving unit is temporarily stopped.

2. The apparatus of claim 1, wherein the lens position sensing unit comprises:
a position sensor sensing the position of the lens and outputting an analog signal corresponding to the sensed position of the lens; and
an analog-to-digital converter converting the analog signal into a digital format and generating the sensed lens position value.

3. The apparatus of claim 2, wherein the lens control unit controls the analog-to-digital converter so that the analog-to-digital converter generates a new sensed lens position value by using an analog signal input from the position sensor while the operation of the actuator driving unit is temporarily stopped, and maintains the previous sensed lens position value while the actuator driving unit operates.

4. A method of driving a piezoelectric actuator comparing a target lens position value determined for auto-focus with a sensed lens position value obtained by sensing the actual position of a lens and moving the lens to make the target lens position value and the sensed lens position value equal to each other, the method comprising:
determining the target lens position value;
determining whether or not to generate a new sensed lens position value;
stopping generation of a driving signal for driving the piezoelectric actuator when it is determined to generate a new sensed lens position; and
comparing the sensed lens position value, generated while the generation of the driving signal is stopped, with the target lens position value and generating a driving signal for driving the piezoelectric actuator according to a result of the comparison.
